(19) United States
(12) Patent Application Publication
(10) Pub. No.: US 2014/0118873 A1
(43) Pub. Date: May 1, 2014

(54) POWER MODULE AND APPARATUS FOR PREVENTING MALFUNCTION, AND METHOD OF CONTROLLING THEREOF

(71) Applicant: SAMSUNG ELECTRO-MECHANICS CO., LTD., Suwon (KR)

(72) Inventor: Jun Ho Lee, Suwon (KR)

(73) Assignee: SAMSUNG ELECTRO-MECHANICS CO., LTD., Suwon (KR)

(21) Appl. No.: 13/761,360

(22) Filed: Feb. 7, 2013

(30) Foreign Application Priority Data
Oct. 31, 2012 (KR) 10-2012-0122519

(51) Int. Cl. H02H 3/20

(52) U.S. Cl. CPC H02H 3/20
USPC 361/91.5

(57) ABSTRACT

Disclosed herein are a power module and apparatus for preventing malfunction, and a method of controlling thereof. The power module includes a drive IC that includes a protection circuit for preventing damage to the power module due to input electrical signals and a driving circuit connected to the protection circuit so as to control a switching operation of a switching element, and the switching element that is controlled by the driving circuit so as to perform the switching operation. Here, the drive IC includes a back-to-back diode for clamping an overvoltage of the input electrical signals.

### CROSS REFERENCE TO RELATED APPLICATION

This application claims the benefit of Korean Patent Application No. 10-2012-0122519, filed on Oct. 31, 2012, entitled “Power Module and Apparatus Having the Preventing Malfunction and Method Thereof”, which is hereby incorporated by reference in its entirety into this application.

### BACKGROUND OF THE INVENTION

1. Technical Field

The present invention relates to a power module and apparatus for preventing malfunction, and a method of controlling thereof.

2. Description of the Related Art

An Intelligent Power Module (IPM) is one type of power module and includes a power semiconductor element such as an insulated gate bipolar mode transistor (IGBT), a metal oxide silicon field effect transistor (MOSFET), a fast recovery diode (FRD), and the like, a control circuit, a driving circuit, a protection circuit, and a control power source in a single package. The IPM may implement an input/output voltage and current, a control method of the IPM, an available shape and size, and the like in a variety of manners in accordance with the purpose of use and requirements of a used system.

A general-purpose inverter, which is an application device currently used in power electronic fields, includes a numerically controlled (NC) machine tool, an industrial robot, and the like require high efficiency and miniaturization together with their progress. The IGBT that is a switch used in the IPM enables an apparatus to be highly functionalized and miniaturized. The IPM has advantages that reduce the number of peripheral circuits and components by interconnection, in which peripheral circuits such as a driving circuit, a variety of protection circuits, and the like are mounted in a module package, and reduce the design period of a system. In addition, in the IPM, a wiring length between an inner driver circuit and a power switching element of the IPM is short, and an impedance of the driver circuit is low, and therefore electronic magnetic interference (EMI) characteristics and parasitic effect immunity are improved.

In the earlier development of the IPM, a driving circuit or a protection circuit is simply inserted in a power device module of the related art to thereby implement the IPM. In recent years, the IPM in which IGBT, a MOSFET element, and a dedicated integrated circuit (IC) are mounted has been mainly used. That is, a currently designed IPM requires an optimized design in which control and protection functions of system and element are comprehensively considered, rather than mounting a control circuit or the like in a signal module. Therefore, the IPM should be designed so as to consider low noise (high frequency), high efficiency (low loss), ruggedness, stable control, miniaturization and reduction in weight, easiness in design and assembly, and the like, which are required of a system, and to satisfy high-speed switching, low loss, optimized trade-off design with respect to safe operating areas (SOA), appropriate protection measures, high noise stability, miniaturization and reduction in weight (high integrity) which are distinguished from when being used as an individual element from the point of view of the switching element.

In such a power module, as a method of preventing an over-current, voltages of both ends of a shunt resistance are sensed using the shunt resistance, and when the sensed voltages of both ends are larger than a reference voltage of a drive integrated circuit (IC), an over-current protection function is operated so as to turn off an output, thereby protecting the power module.

However, in this method, switching noise may occur due to operations of the switching element, and malfunction may occur when the switching noise flows in a current sensing input terminal.

### PRIOR ART DOCUMENT

### Patent Document

(Patent Document 1) JP 1994-284710

### SUMMARY OF THE INVENTION

The present invention has been made in an effort to provide a power module that prevents malfunction of the module due to an electrical overvoltage caused by electronic magnetic interference (EMI) noise, a serge voltage, or the like, and an apparatus thereof.

The present invention has been also made in an effort to provide a method of controlling a power module due to an electrical overvoltage caused by EMI noise, a serge voltage, or the like.

According to a preferred embodiment of the present invention, there is provided a power module including: a drive integrated circuit (IC) that includes a protection circuit for preventing damage to the power module due to input electrical signals and a driving circuit connected to the protection circuit so as to control a switching operation of a switching element; and the switching element that is controlled by the driving circuit so as to perform the switching operation. Here, the drive IC may include a back-to-back diode for clamping an overvoltage of the input electrical signal.

In addition, in the back-to-back diode, cathodes of two Zener diodes may face each other.

In addition, the protection circuit may calculate the number of electrical signals of the clamped overvoltage using the back-to-back diode, and may control the switching operation of the switching element so as to suspend the operation of the power module when the calculated number of electrical signals is a predetermined value or larger.

Meanwhile, according to another preferred embodiment of the present invention, there is provided a power module including: a drive IC that includes a protection circuit for preventing damage to the power module due to input electrical signals and a driving circuit connected to the protection circuit so as to control a switching operation of a switching element; the switching element that is controlled by the driving circuit so as to perform the switching operation; and a back-to-back diode that is positioned at a front end of an input unit of the drive IC so as to clamp an overvoltage of the electrical signals input to the drive IC.

In addition, in the back-to-back diode, cathodes of two Zener diodes may face each other.

In addition, the protection circuit may calculate the number of electric signals for the clamped overvoltage using the back-to-back diode, and may turn off the switching element when the calculated number of electric signals is a predetermined value or larger.

Meanwhile, according to a preferred embodiment of the present invention, there is provided a power module apparatus including: a printed circuit board; a power module that is mounted on the printed circuit board and includes a drive IC having a protection circuit for preventing damage to the power module due to an input electrical signal, a switching element for performing a switching operation, and a driving circuit for being connected to the protection circuit and controlling the switching operation of the switching element; and a back-to-back diode that is mounted on the printed circuit board and connected to an input unit of the drive IC so as to clamp an overvoltage of the input electrical signals.

In addition, in the back-to-back diode, cathodes of two Zener diodes may face each other.

In addition, the protection circuit may calculate the number of clamped electric signals for the overvoltage using the back-to-back diode, and may turn off the switching element when the calculated number of clamped electric signals is a predetermined value or larger.

Meanwhile, according to a preferred embodiment of the present invention, there is provided a method of controlling a power module including: clamping an overvoltage of electrical signals input to a drive IC included in a power module using a back-to-back diode; and controlling a switching operation of a switching element included in the power module based on the clamped electrical signals.

In addition, in the back-to-back diode, cathodes of two Zener diodes may face each other.

In addition, the drive IC may include a protection circuit for preventing damage to the power module due to the input electrical signals, and a driving circuit that is connected to the protection circuit and an upper control layer so as to control the switching operation of the switching element.

In addition, the back-to-back diode may be integrated into the drive IC to thereby be implemented.

In addition, the back-to-back diode may be implemented inside the power module to thereby be implemented in a front end of an input unit of the drive IC.

In addition, the back-to-back diode may be implemented outside the power module.

In addition, the method of controlling a power module may further include measuring a current flowing between a collector and an emitter of the switching element using a shunt resistance to thereby determine whether the current inputting to the drive IC is an over-current.

In addition, the controlling of the switching operation may further include calculating the number of clamped electrical signals for the overvoltage using the back-to-back diode, and turning off the switching element when the calculated number of the clamped electrical signals is a predetermined value or larger.

In addition, the overvoltage of the electric signals may be a pulsed serge generated due to the switching operation of the switching element or may be electronic magnetic interference (EMI) generated from the outside of the power module.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a conceptual diagram briefly showing a power module according to a first embodiment of the present invention;

FIG. 2 is a conceptual diagram showing a waveform of an electromagnetic overvoltage according to an embodiment of the present invention;

FIG. 3 is a conceptual diagram briefly showing a power module according to a second embodiment of the present invention;

FIG. 4 is a conceptual diagram showing a power module apparatus according to a first embodiment of the present invention; and

FIG. 5 is a flowchart showing a method of controlling a power module (apparatus of the power module) by preventing an electromagnetic overvoltage according to a first embodiment of the present invention.

### DESCRIPTION OF THE PREFERRED EMBODIMENTS

The objects, features, and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side”, and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the accompanying drawings.

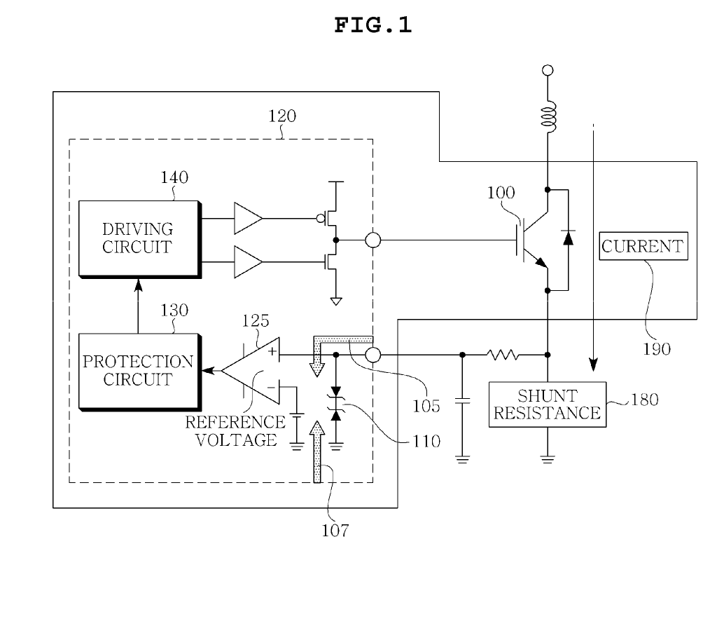

FIG. 1 is a conceptual diagram briefly showing a power module according to a first embodiment of the present invention.

Referring to FIG. 1, a drive integrated circuit (IC) 120 and a shunt resistance 180 may be connected to each other with respect to an insulated gate bipolar mode transistor (IGBT) 100 that is a single switching element.

The drive IC 120 may include a protection circuit 130 (protection logic) and a driving circuit 140 (driving logic).

For example, the driving circuit 140 may determine whether to drive the IGBT 100 by signals inputting from an upper control unit (not shown) such as the protection circuit 130 or a central processing unit (CPU).

The protection circuit 130 may be implemented so as to prevent damage caused by abnormal electrical signals such as short-current (SC), over-current (OC), under-voltage (UV), or over-temperature (OT), and external factors. For example, when an over-current or an overvoltage occurs, the protection circuit 130 may generate a fault output voltage to thereby allow the driving circuit 140 to control operations of the IGBT 100. In the protection circuit, a current flowing in the IGBT may be detected using a current detecting resistance to thereby determine whether the detected current is the SC or OC.

The protection circuit 130 may include, for example, a low voltage protection circuit, an SC protection circuit, an OC protection circuit, and an OT protection circuit. These protection circuits are given as an example, and an additional protection circuit may be further included in the protection circuit 130, or a part of the protection circuits may not be implemented.

A protecting operation by each circuit may be performed as below.

In the low voltage protection circuit, when a voltage of a power source drops to a reference voltage or less, an inner driving circuit 240 may turn off the IGBT 200 to thereby protect a system.

The SC protection circuit may detect voltages of both ends using an output current detecting resistance to thereby detect a short-current. In a case in which a circuit is shorted for a predetermined period or longer due to any abnormal phenomena, when the voltages of both ends of the output current detecting resistance are equal to or greater than a reference voltage (P2), and are maintained for a predetermined period or longer, such phenomenon is recognized as a short-current phenomenon, and therefore the inner driving circuit 140 turns off the IGBT 100 to thereby protect the system.

When the voltages of both ends of the output current detecting resistance are equal to or greater than the reference voltage (P2), and are maintained for a predetermined period or longer, the OC protection circuit may recognize such a phenomenon as an over-current phenomenon, and therefore the inner driving circuit 140 turns off the IGBT 100 to thereby protect the system.

In the OT protection circuit, when a temperature of a heat sink of the IPM rises to a reference temperature or higher, the inner driving circuit 140 turns off the IGBT 100 to thereby protect the system.

Even the shunt resistance 180 connected to the IGBT 100 may be used in measuring an over-current. When input power input to the IGBT 100 is normal, a current 190 flowing based on a voltage between a collector and an emitter of the IGBT 100 does not correspond to the over-current. However when any abnormality occurs during the input of power, the current 190 flowing based on the voltage between the collector and the emitter of the IGBT 100 becomes an over-current.

The shunt resistance 180 may convert an over-current detected value into a voltage so as to be detected. A voltage comparator 125 may be included in the drive IC 120. Here, whether an over-current currently flows in the IGBT 100 by comparing a reference voltage of the voltage comparator 125 and a voltage generated due to the shunt resistance 180, and when the over-current flows in the IGBT 100, the inner driving circuit 140 turns off the IGBT 100 to thereby protect a system.

That is, the flowing over-current is sensed based on the shunt resistance 180, and a result of the sensing is input to the drive IC 120, and therefore an operation of the IGBT 100 may be suspended when the over-current flows to thereby prevent the switch from being damaged, and enable the IPM to be operated normally.

When an operation of the IGBT 100 is controlled by the protection circuit 130, switching noise may occur due to a switching operation. The switching noise may be noise of a high frequency generated due to a method of turning on/off, at a high speed, a current flowing by a semiconductor element when using switching power. When the switching noise occurs, the switching noise may affect sensing of the current resulting in a malfunction of the IPM. In addition, there is a possibility of a malfunction of the IPM due to a peripheral environment in which the IPM operates, and the inner circuit element.

That is, in the IPM, a method for preventing electronic magnetic interference (EMI) generated by the switching noise, an operational environment, or the inner circuit element, or an electromagnetic over-current such as a serge voltage, and controlling these abnormal electrical signals is required. The electromagnetic over-current generated in the circuit may exist in a variety of manners as below.

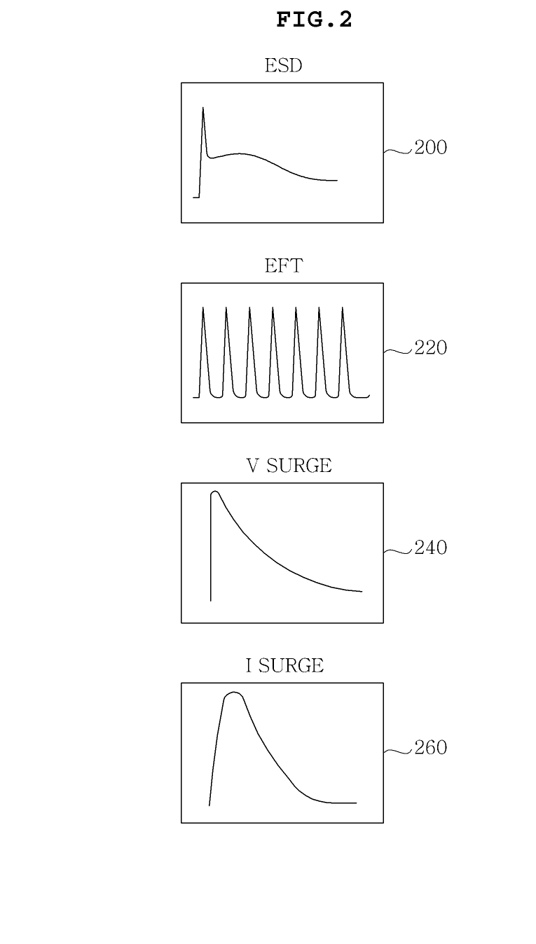

FIG. 2 is a conceptual diagram showing a waveform of an electromagnetic overvoltage according to an embodiment of the present invention.

Referring to FIG. 2, the electromagnetic overvoltage refer to pulsed electromagnetic interference such as electrostatic discharge (ESD) 200, electric fast transient (EFT/burst) 220, serge 240 and 260, and the like which may be exerted on the circuit.

(1) Electrostatic Discharge (ESD) 200

ESD as an EMI phenomenon that may occur due to friction refers to a phenomenon that occurs when charges accumulated on a person or an object are suddenly emitted. For example, such an ESD may occur due to friction occurring in a periphery of an IPM module, and in this instance, the circuit may malfunction.

(2) Electric Fast Transient (EFT/Burst) 220

Electromagnetic noise may excessively occur in a device in which a current change per unit time is fast, such as a motor. For example, when a switch for controlling a motor is blocked off, a voltage spike occurs resulting in a voltage drop. When polarity of the current is changed again, a voltage increase occurs due to operations of an inductor and a capacitor of the motor again. A burst occurs due to such an EFT/burst phenomenon. Such an EFT/Burst becomes a cause of the malfunction of the circuit.

(3) Serge 240 and 260

The serge denotes a high energy and short sustain pulse that is caused by lightning or switching of a power source. Since energy per pulse is large when the serge occurs, the IPM may be considerably damaged.

According to an embodiment of the present invention, in order to prevent an overvoltage in the IPM, an abnormal voltage may be prevented using a back-to-back diode.

Referring again to FIG. 1, the back-to-back diode 110 may be included in the drive IC of the power module according to an embodiment of the present invention to thereby be implemented. The back-to-back diode 110 may be provided at a front end of the protection circuit 130. The back-to-back diode 110 has a diode structure with bidirectionality, and may indicate an electrical element that may clamp an abnormal overvoltage of a predetermined voltage or greater inputting from both ends thereof.

The back-to-back diode 110 may be implemented as a structure in which, for example, cathodes of two Zener diodes face each other. However, the back-to-back diode 110 may be implemented using a different diode structure other than the Zener diode.

The Zener diode is a diode that may be used for adjusting a voltage. When a predetermined voltage or greater is exerted at both ends of the diode, the Zener diode has a property that may limit the voltage so that the voltage is not additionally exerted. Two Zener diodes are put together so as to clamp an overvoltage that inputs bidirectionally, and therefore only a voltage of a predetermined voltage or less may be input.

For example, when the pulsed serge 105 occurs by the switching of the IGBT 100, the back-to-back diode 110 may block the pulsed serge at the front end of the protection circuit 130 so that the pulsed serge does not input to the drive IC 120. In addition, the back-to-back diode 110 may bidirectionally block the pulsed serge 107 that is generated in a reverse direction from the outside of the drive IC.

The back-to-back diode 110 may be used for blocking different EMIs such as the ESD phenomenon or the EFT/burst phenomenon described above as well as the pulsed serge.

The back-to-back diode 110 is integrated with the drive IC 120 so as to be implemented, thereby achieving miniaturization and reduction in weight of the module. A position of the back-to-back diode 110 for preventing overvoltage shown in FIG. 2 is arbitrary, and the back-to-back diode 110 may be also implemented in other positions in order to prevent overvoltage.

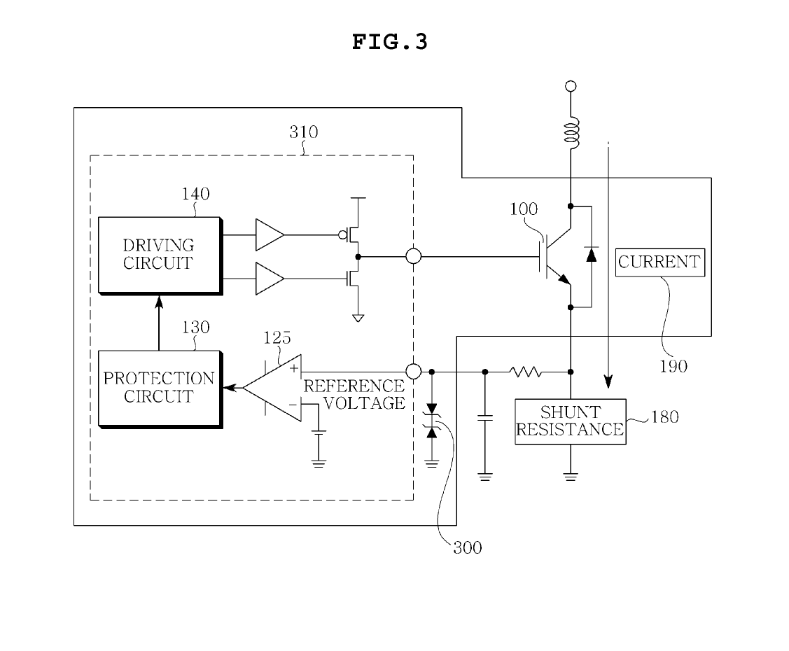

FIG. 3 is a conceptual diagram briefly showing a power module according to a second embodiment of the present invention.

Referring to FIG. 3, as still another embodiment of the present invention, a back-to-back diode 300 may be implemented at a front end of a drive IC 310 without being integrated in the drive IC 310 while being implemented inside the module. The back-to-back diode 300 implemented at the front end of the drive IC 310 may block an overvoltage input to the drive IC 310.

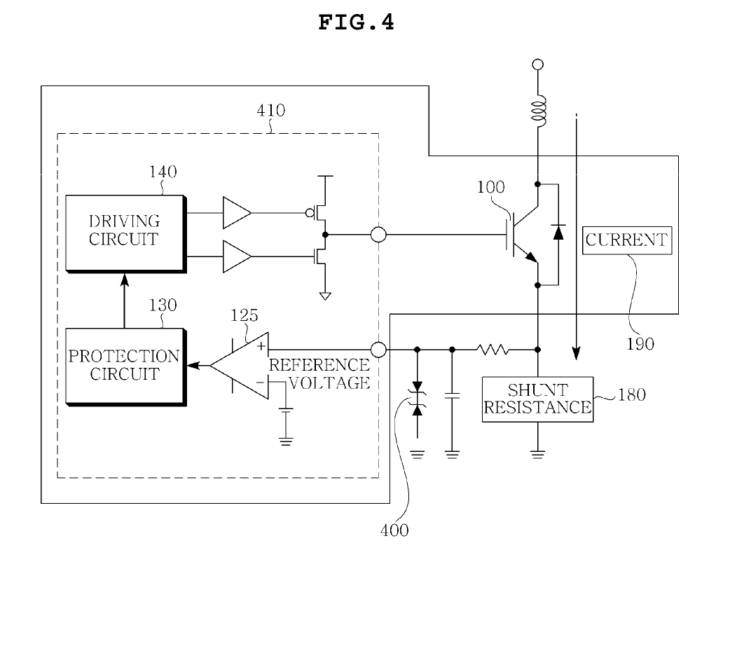

FIG. 4 is a conceptual diagram showing a power module apparatus according to the first embodiment of the present invention.

Referring to FIG. 4, in the power module apparatus according to the first embodiment of the present invention, a back-to-back diode 400 is implemented on a printed circuit board (PCB) of the outside of the module to thereby prevent an overvoltage input from a front end of the drive IC 410. A cooling plate may be installed on a surface of the IPM so as to emit heat generated in the IPM, and therefore the heat generated in the IPM may be emitted through the cooling plate.

When the back-to-back diode is damaged due to the fact that the back-to-back diode is not integrated in the drive IC as shown in FIGS. 3 and 4, only the damaged portion of the back-to-back diode may be replaced without replacing the entire drive IC. The embodiments shown in FIGS. 3 and 4 are also an example, and the back-to-back diode may be implemented in other positions in order to prevent the overvoltage.

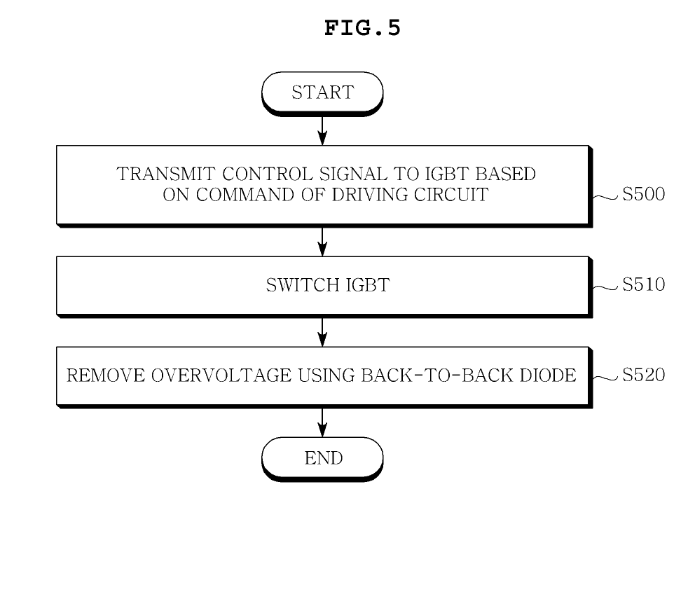

FIG. 5 is a flowchart showing a method of controlling a power module (apparatus of the power module) by preventing an electromagnetic overvoltage according to a first embodiment of the present invention.

In FIG. 5, a case in which pulsed serge occurs by switching has been described for convenience of description, but the present invention may be applied to all processes that prevent an EMI using the back-to-back diode.

Referring to FIG. 5, in step S500, a control signal is transmitted to an IGBT based on a command transmitted from a driving circuit.

The driving circuit may receive a command for turning on a switch of the IGBT by an upper control unit such as a CPU or a protection circuit. In this case, the driving circuit may transmit an electrical command to thereby drive the IGBT so that the IGBT performs a switching operation.

Next, in step S510, the IGBT is switched.

Switching may be performed in such a manner that a switch of the IGBT is turned on when the switch is turned off by a control single transmitted by the driving circuit, and the switch is turned off when the switch is turned on. When the switching is performed, the above-described overvoltage such as the pulsed serge may occur.

In step S520, an overvoltage is limited using a back-to-back diode.

In order to prevent the overvoltage generated by the switching of the IGBT from being input to the drive IC, the overvoltage may be clamped using the back-to-back diode. For example, in a case of using a Zener diode, when a voltage of an electrical signal inputting to the drive IC is equal to or greater than a Zener breakdown voltage, the voltage of equal to or greater than the predetermined voltage may be clamped to thereby enable only signals with equal to or less than the predetermined voltage to be input. That is, the back-to-back diode prevents an overvoltage from being input to the drive IC to thereby prevent an abnormal overvoltage from being input to a gate of an amplification switch device such as the IGBT as feedback, thereby preventing damages to the amplification switch device such as the IGBT.

According to the embodiments of the present invention, in order to prevent damage to the back-to-back diode when an overvoltage continuously occurs, the switch of the IGBT may be turned off. For example, a memory of recording a generation frequency of the overvoltage in the protection circuit or the driving circuit which have been described in FIG. 3 may be included. When the overvoltage that is continuously generated in the protection circuit is detected, the protection circuit may command the driving circuit to turn off the IGBT. In order to command a turn off of the IGBT, a threshold value for commanding to turn off of the IGBT such as a consecutive generation frequency of the overvoltage, a generation period thereof, or the like may be set in advance in the protection circuit. This determination may be performed in a unit such as a CPU that is an upper control unit rather than the protection circuit.

Using such a method, damage to the back-to-back diode may be prevented, and damage to the IPM may be further prevented.

As described above, according to the embodiments of the present invention, malfunction due to EMI noise or serge voltage input to the drive IC may be prevented using the back-to-back diode, and therefore a malfunction of the power module may be prevented, and damage to the switching element may be prevented.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations, or equivalent arrangements should be considered to be within the scope of the invention, and the detailed scope of the invention will be disclosed by the accompanying claims.

What is claimed is:

1. A power module comprising:
a drive integrated circuit (IC) that includes a protection circuit for preventing damage to the power module due to input electrical signals and a driving circuit connected to the protection circuit so as to control a switching operation of a switching element; and
the switching element that is controlled by the driving circuit so as to perform the switching operation,
wherein the drive IC includes a back-to-back diode for clamping an overvoltage of the input electrical signals.

2. The power module as set forth in claim 1, wherein in the back-to-back diode, cathodes of two Zener diodes face each other.

3. The power module as set forth in claim 1, wherein the protection circuit calculates the number of electrical signals of the clamped overvoltage using the back-to-back diode, and controls the switching operation of the switching element so as to suspend the operation of the power module when the calculated number is a predetermined value or larger.

4. A power module comprising:
a drive IC that includes a protection circuit for preventing damage due to input electrical signals and a driving circuit connected to the protection circuit so as to control a switching operation of a switching element;
the switching element that is controlled by the driving circuit so as to perform the switching operation; and
a back-to-back diode that is positioned in a front end of an input unit of the drive IC so as to clamp an overvoltage of the electrical signals input to the drive IC.

5. The power module as set forth in claim 4, wherein in the back-to-back diode, cathodes of two Zener diodes face each other.

6. The power module as set forth in claim 4, wherein the protection circuit calculates the number of electric signals for the clamped overvoltage using the back-to-back diode, and turns off the switching element when the calculated number of electric signals is a predetermined value or larger.

7. A power module apparatus comprising:
a printed circuit board;
a power module that is mounted on the printed circuit board and includes a drive IC having a protection circuit for preventing damage due to input electrical signals, a switching element for performing a switching operation, and a driving circuit for being connected to the protection circuit and controlling the switching operation of the switching element; and
a back-to-back diode that is mounted on the printed circuit board and connected to an input unit of the drive IC so as to clamp an overvoltage of the input electrical signals.

8. The power module apparatus as set forth in claim 7, wherein in the back-to-back diode, cathodes of two Zener diodes face each other.

9. The power module apparatus as set forth in claim 7, wherein the protection circuit calculates the number of clamped electrical signals for the overvoltage using the back-to-back diode, and turns off the switching element when the calculated number of clamped electric signals is a predetermined value or larger.

10. A method of controlling a power module, comprising:
clamping an overvoltage of electrical signals input to a drive IC included in a power module using a back-to-back diode; and
controlling a switching operation of a switching element included in the power module based on the clamped electrical signals.

11. The method of controlling a power module as set forth in claim 10, wherein in the back-to-back diode, cathodes of two Zener diodes face each other.

12. The method of controlling a power module as set forth in claim 10, wherein the drive IC includes:
a protection circuit for preventing damage to the power module due to the input electrical signals; and
a driving circuit that is connected to the protection circuit and an upper control layer so as to control the switching operation of the switching element.

13. The method of controlling a power module as set forth in claim 10, wherein the back-to-back diode is integrated into the drive IC to thereby be implemented.

14. The method of controlling a power module as set forth in claim 10, wherein the back-to-back diode is implemented inside the power module to thereby be implemented in a front end of an input unit of the drive IC.

15. The method of controlling a power module as set forth in claim 10, wherein the back-to-back diode is implemented outside the power module.

16. The method of controlling a power module as set forth in claim 10, further comprising:
measuring a current flowing between a collector and an emitter of the switching element using a shunt resistance to thereby determine whether a current input to the drive IC is an over-current.

17. The method of controlling a power module as set forth in claim 10, wherein the controlling of the switching operation of the switching element further includes:
calculating the number of clamped electrical signals for the overvoltage using the back-to-back diode; and
turning off the switching element when the calculated number of clamped electrical signals is a predetermined value or larger.

18. The method of controlling a power module as set forth in claim 10, wherein the overvoltage of the electrical signals is a pulsed serge generated due to the switching operation of the switching element, or is electronic magnetic interference (EMI) generated from the outside of the power module.
